(19) United States
(12) Patent Application Publication
(10) Pub. No.: US 2004/0186878 A1
(43) Pub. Date: Sep. 23, 2004

(54) Internet service provider facilitating IPv6 connectivity across a customer's network containing IPv4 components

(76) Inventors: Shu Yamamoto, Cupertino, CA (US); Hidetoshi Yokota, Saitama-Shi (JP); Carl Williams, Palo Alto, CA (US); Kazuo Hashimoto, Palo Alto, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/436,679

(22) Filed: May 12, 2003

Related U.S. Application Data
(60) Provisional application No. 60/448,957, filed on Feb. 21, 2003.

(51) Int. Cl. G06F 15/16

(52) U.S. Cl. 709/200

(57) ABSTRACT

An Internet Service Provider provides IPv6 connectivity to a customer without requiring that the customer upgrade its network containing IPv4 components. The Internet Service Provider makes at least one point of presence including at least one IPv6 Connect Agent available to customers. The Internet Service Provider allows a customer's IPv6 enabled node located within the customer's network containing IPv4 components to automatically discover an IPv6 Connect Agent. The Internet Service Provider facilitates IPv6 communication between the customer's IPv6 enabled node and the discovered IPv6 Connect Agent, across the customer's network containing IPv4 components. The Internet Service Provider also facilitates IPv6 communication between the discovered IPv6 Connect Agent and an IPv6 entity located outside of the customer's network containing IPv4 components, thereby providing IPv6 communication between the customer's IPv6 enabled node and the IPv6 entity located outside of the customer's network containing IPv4 components.

### CROSS-REFERENCE TO RELATED APPLICATIONS

This application claims priority under 35 U.S.C. § 119(e) from U.S. Provisional Patent Application Serial No. 60/448,957, filed Feb. 21, 2003, the entirety of which is incorporated herein by reference.

### BACKGROUND

1. Field of Invention

The present invention relates generally to Internet protocol communication, and specifically to an Internet Service Provider facilitating Internet Protocol Version 6 communication over a customer's network containing Internet Protocol Version 4 components.

2. Background of Invention

Internet Protocol Version 6 (“IPv6”) is the most current Internet protocol, designed to replace the widely used Internet Protocol Version 4 (“IPv4”). Although most of the Internet is still using IPv4, there is a shortage of IPv4 addresses. This is a significant problem, because an Internet Protocol address is required by each computer connected to the Internet. IPv6 fixes a number of shortcomings related to IPv4, including the limited number of available IPv4 addresses. IPv6 is expected to gradually replace IPv4, with the two coexisting for a number of years during a transition period. Thus, the transition from IPv4 to IPv6 is currently an important concern among user's of the Internet, from individuals to large enterprises.

Many users already have computers which are IPv6 enabled (e.g., by the use of connectivity services provided with the operating system). However, these IPv6 enabled computers are typically installed in IPv4 networks, which have not been updated for IPv6, or in mixed IPv4/IPv6 networks, which still contain IPv4 non-upgraded components. Previous IPv6 transition scenarios require that changes be made to the IPv4 network in which the IPv6 node is located. This requires that a network administrator learn IPv6, and then perform a potentially expensive and complicated IPv6 upgrade of the network. Many local network administrators are not yet be ready to deploy IPv6. Thus, individual IPv6 enabled nodes (either stationary or mobile) within these networks are unable to engage in IPv6 communication with IPv6 entities outside of their local IPv4 networks.

Many Internet user's access the Internet through an Internet Service Provider. Many Internet Service Providers are not providing IPv6 connectivity to their customers at all, sometimes because the Internet Service Provider has enough IPv4 addresses for its customers, and has decided not to upgrade. Those Internet Service Providers that do provide IPv6 connectivity to their customers require that their customers have local networks which have been upgraded to IPv6. Thus, an Internet Service Provider customer with individual IPv6 enabled nodes within an IPv4 network cannot engage in IPv6 Internet communication, even where the Internet Service Provider is a provider of IPv6 connectivity to customers with IPv6 networks.

What is needed are methods and systems for an Internet Service Providers to provide IPv6 connectivity to IPv6 enabled nodes within IPv4 networks or mixed IPv4/IPv6 networks, without requiring that the local IPv4 or mixed IPv4/IPv6 network be upgraded.

### SUMMARY OF INVENTION

An Internet Service Provider provides IPv6 connectivity to a customer without requiring that the customer upgrade its network. In some embodiments the customer's network is an IPv4 network, and in other embodiments the customer's network is a mixed network, in which some components are still IPv4, but others components have been upgraded to IPv6. In some embodiments, the Internet Service Provider makes at least one point of presence including at least one IPv6 Connect Agent available to customers. The Internet Service Provider allows a customer's IPv6 enabled node located within the customer's IPv4 or mixed network to automatically discover an IPv6 Connect Agent. The Internet Service Provider facilitates IPv6 communication between the customer's IPv6 enabled node and the discovered IPv6 Connect Agent, across the customer's network. The Internet Service Provider also facilitates IPv6 communication between the discovered IPv6 Connect Agent and an IPv6 entity located outside of the customer's IPv4 or mixed network, thereby providing IPv6 communication between the customer's IPv6 enabled node and the IPv6 entity located outside of the customer's network. In some embodiments the customer's IPv6 enabled node is stationary, and in other embodiments it is mobile. In some embodiments, the Internet Service Provider charges the customer special rates for facilitating the IPv6 communication over the IPv4 or mixed network.

The features and advantages described in this summary and the following detailed description are not all-inclusive, and particularly, many additional features and advantages will be apparent to one of ordinary skill in the art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1A is a block diagram illustrating a high level overview of an Internet Service Provider providing IPv6 connectivity to a customer without requiring that the customer upgrade its IPv4 network, according to one embodiment of the present invention.

FIG. 1B is a block diagram illustrating a high level overview of an Internet Service Provider providing IPv6 connectivity to a customer without requiring that the customer upgrade its mixed IPv4/IPv6 network, according to one embodiment of the present invention.

FIG. 2 is a flowchart illustrating steps for an Internet Service Provider to provide IPv6 connectivity to a customer without requiring that the customer upgrade its network containing IPv4 components, according to one embodiment of the present invention.

FIG. 3 is a block diagram illustrating an Internet Service Provider providing a plurality of points of presence each including at least one IPv6 Connect Agent, according to one embodiment of the present invention.

FIG. 4 is a flowchart illustrating steps for an Internet Service Provider that includes a plurality of points of presence to provide IPv6 connectivity to a customer without requiring that the customer upgrade its network containing IPv4 components, according to one embodiment of the present invention.

FIG. 5 is a block diagram illustrating an Internet Service Provider point of presence that includes an IPv4 communication module, according to one embodiment of the present invention.

FIG. 6 is a block diagram illustrating an Internet Service Provider facilitating mobile IPv6 communication for a customer's IPv6 enabled mobile node, according to some embodiments of the present invention.

FIG. 7 is a flowchart illustrating steps for executing a special billing model, according to one embodiment of the present invention.

FIG. 8 is a flowchart illustrating steps for executing another special billing model, according to another embodiment of the present invention.

The figures depict embodiments of the present invention,for purposes of illustration only. One skilled in the art will readily recognize from the following discussion that alternative embodiments of the structures and methods illustrated herein may be employed without departing from the principles of the invention described herein.

### DETAILED DESCRIPTION OF PREFERRED EMBODIMENTS

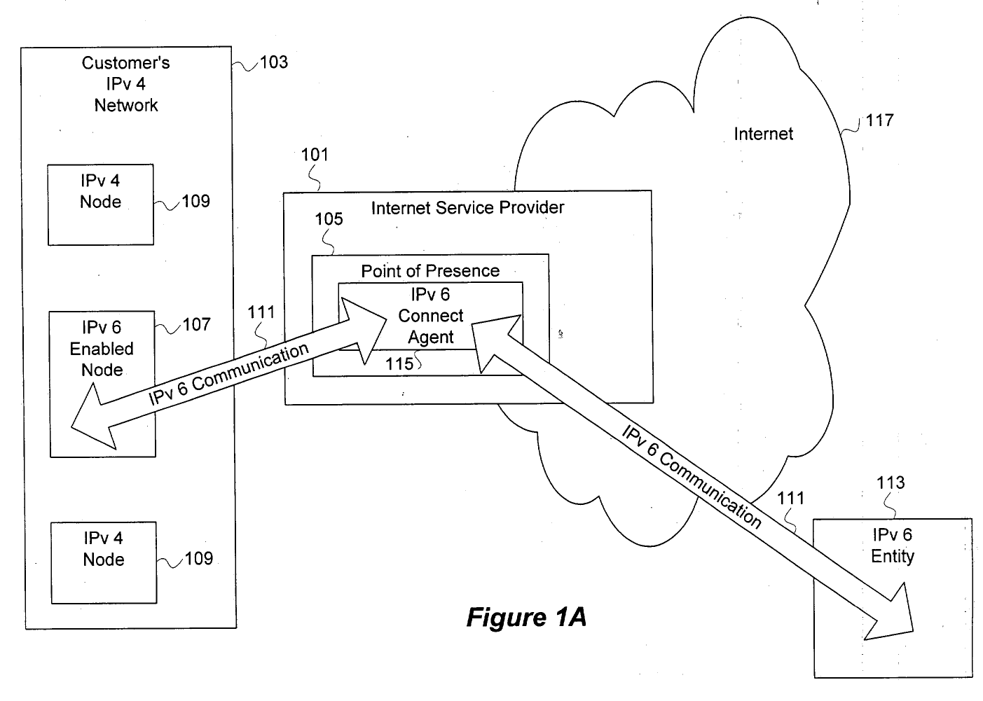

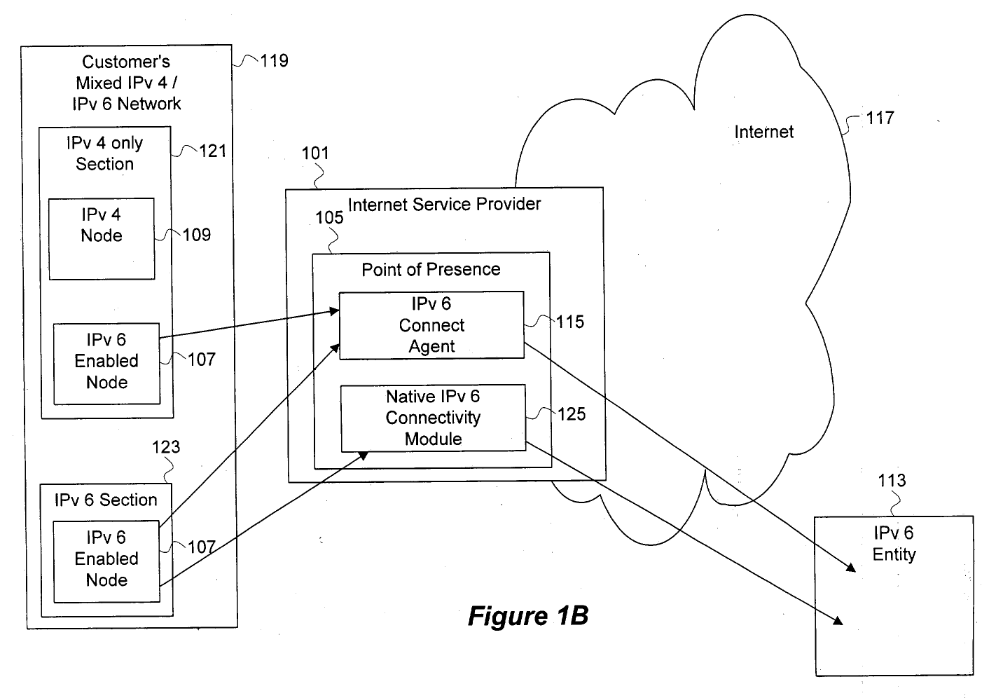

FIG 1A illustrates a high level overview of an Internet Service Provider 101 providing IPv6 connectivity to a customer without requiring that the customer upgrade its IPv4 network 103, according to one embodiment of the present invention. It is to be understood that in other embodiments, an Internet Service Provider 101 provides IPv6 connectivity to a customer without requiring that the customer upgrade its mixed IPv4/IPv6 network, as explained below in greater detail in conjunction with FIG. 1B. As illustrated in FIG. 1A, a customer's IPv4 network 103 includes at least one IPv6 enabled node 107. Note that the customer's IPv4 network 103 also contains IPv4 nodes 109. The Internet Service Provider 101 makes at least one point of presence 105 including at least one IPv6 Connect Agent 115 available to customers. “IPv6 Connect Agent” 115 as used herein simply means a node that includes the functionality required to enable an IPv6 enabled node 107 residing in an IPv4 network 103 to engage in IPv6 communication 111 across the IPv4 network 103. In some embodiments, an IPv6 Connect Agent 115 is implemented as a server residing inside the Internet Service Provider's 101 backbone that encompasses special protocol to enable the IPv6 connectivity without requiring changes to the customer's IPv4 network 103, or mixed network.

The Internet Service Provider 101 allows the customer's IPv6 enabled node 107 to automatically discover an IPv6 Connect Agent 115 located in an Internet Service Provider 101 point of presence 105. The implementation mechanics of allowing automatic discovery of an IPv6 Connect Agent 115 are understood by those of ordinary skill in the relevant art. In some embodiments, the discovered IPv6 Connect Agent 105 comprises an IPv6 Connect Agent 115 that is physically closest to the customer's IPv6 enabled node 107, as discussed in more detail below.

The Internet Service Provider 101 proceeds to facilitate IPv6 communication 111 between the customer's IPv6 enabled node 107 and the discovered IPv6 Connect Agent 105, across the customer's IPv4 network 103. Methods for providing IPv6 communication 111 across an IPv4 network 103 are known by those of ordinary skill in the relevant art, e.g., tunneling. The Internet Service Provider 101 also facilitates IPv6 communication 111 between the discovered IPv6 Connect Agent 105 and an IPv6 entity 113 located outside of the customer's IPv4 network 103, thereby providing IPv6 communication 111 between the customer's IPv6 enabled node 107 and the IPv6 entity 113 located outside of the customer's IPv4 network 103. Typically, the facilitation of IPv6 communication across the customer's IPv4 network is performed by the discovered IPv6 Connect Agent 115, located within an Internet Server Provider 101 point of presence 101, as illustrated in FIG. 1A.

In some embodiments, the Internet Service Provider 101 facilitating IPv6 communication 111 between the discovered IPv6 Connect Agent 105 and an IPv6 entity 113 located outside of the customer's IPv4 network 103 comprises the Internet Service Provider 101 facilitating IPv6 communication 111 across the Internet 117, as illustrated in FIG. 1A. The implementation mechanics of facilitating IPv6 communication 111 across the Internet 117 are understood by those of ordinary skill in the relevant art.

FIG. 1B illustrates a high level overview of an Internet Service Provider 101 providing IPv6 connectivity to a customer without requiring that the customer upgrade its mixed IPv4/IPv6 network 119, according to one embodiment of the present invention. The customer's mixed IPv4/IPv6 network 119 includes an IPv4 only section 121, which includes at least one IPv6 enabled node 107. Note that the IPv4 only section 121 also contains an IPv4 node 109. The customer's mixed IPv4/IPv6 network 119 also includes an IPv6 section 123, which includes at least one IPv6 enabled node 107.

The Internet Service Provider 101 makes at least one point of presence 105 including at least one IPv6 Connect Agent 115 and at least one native IPv6 connectivity module 125 available to customers. The Internet Service Provider 101 allows the customer's IPv6 enabled node 107 located within the IPv4 only section 121 of the customer's mixed network 119 to automatically discover an IPv6 Connect Agent 115 located in an Internet Service Provider 101 point of presence 105. The Internet Service Provider 101 proceeds to facilitate IPv6 communication 111 between the customer's IPv6 enabled node 107 and the discovered IPv6 Connect Agent 105, across the customer's mixed network 119. Methods for providing IPv6 communication 111 across a mixed network 119 are known by those of ordinary skill in the relevant art, e.g., tunneling. The Internet Service Provider 101 also facilitates IPv6 communication 111 between the discovered IPv6 Connect Agent 105 and an IPv6 entity 113 located outside of the customer's mixed network 119, thereby providing IPv6 communication 111 between the customer's IPv6 enabled node 107 and the IPv6 entity 113 located outside of the customer's mixed network 119. Typically, the facilitation of IPv6 communication across the customer's mixed network 119 is performed by the- discovered IPv6 Connect Agent 115, located within an Internet Server Provider 101 point of presence 101, as illustrated in FIG. 1B.

The Internet Service Provider 101 also allows a customer's IPv6 enabled node 107 located within the IPv6 section 123 of the customer's mixed network 119 to automatically discover an IPv6 Connect Agent 115 located in an Internet Service Provider 101 point of presence 105. In some instances, even where the customer's IPv6 enabled node 107 is located within the IPv6 section 123 of the customer's mixed network 119, the customer's IPv6 enabled node 107 will still rely on the IPv6 Connect Agent 115 to obtain configuration information (e.g., Domain Name System information). The Internet Service Provider 101 proceeds to facilitate IPv6 communication 111 between the customer's IPv6 enabled node 107 and the discovered IPv6 Connect Agent 105, across the customer's mixed network 1193. Thus, even where the customer's IPv6 enabled node 107 is located within the IPv6 section 123 of the customer's mixed network 119, the customer's IPv6 enabled node 107 can still obtain transitional IPv6 services from the Internet Service Provider 101.

As illustrated in FIG. 1B, in some instances, the IPv6 enabled node 107 located within the IPv6 section 123 of the customer's mixed network 119 can also connect to a native IPv6 connectivity module 605 provided by the Internet Service Provider 101, which facilitates native IPv6 communication between the IPv6 enabled node 107 and the external IPv6 entity 113 through the mixed IPv4/IPv6 network 119 in a manner that will be apparent to one of ordinary skill in the relevant art.

In some embodiments, the Internet Service Provider 101 facilitating IPv6 communication 111 between the discovered IPv6 Connect Agent 105 or the native IPv6 connectivity module 125 and an IPv6 entity 113 located outside of the customer's IPv4 network 103 comprises the Internet Service Provider 101 facilitating IPv6 communication 111 across the Internet 117, as illustrated in FIG. 1B. The implementation mechanics of facilitating IPv6 communication 111 across the Internet 117 are understood by those of ordinary skill in the relevant art.

It is to be understood that various embodiments of the present invention described herein can be implemented in conjunction with a customer's IPv4 network 103, or in conjunction with a customer's mixed IPv4/IPv6 network 119, as desired. Henceforth, the term “network containing IPv4 components” will be used to mean either an IPv4 network 103, or a mixed IPv4/IPv6 network 119. It is to be understood that where the term “network containing IPv4 components” appears, in some embodiments an IPv4 network 103 is used, and in others a mixed IPv4/IPv6 network 119, as desired.

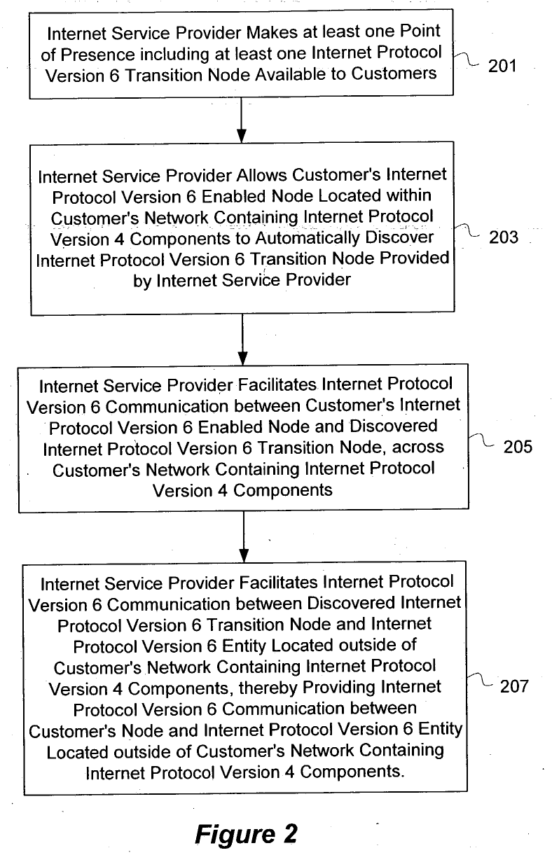

FIG. 2 illustrates steps for an Internet Service Provider 101 to provide IPv6 connectivity to a customer without requiring that the customer upgrade its network containing IPv4 components, according to one embodiment of the present invention. The Internet Service Provider 101 makes 201 at least one point of presence 105 including at least one IPv6 Connect Agent 115 available to customers. The Internet Service Provider allows 203 a customer's IPv6 enabled node 107 located within the customer's network containing IPv4 components to automatically discover an IPv6 Connect Agent 115 located in an Internet Service Provider 101 point of presence 105.

The Internet Service Provider 101 proceeds to facilitate 205 IPv6 communication 111 between the customer's IPv6 enabled node 107 and the discovered IPv6 Connect Agent 115, across the customer's network containing IPv4 components. The Internet Service Provider also facilitates 207 IPv6 communication 111 between the discovered IPv6 Connect Agent 115 and an IPv6 entity 113 located outside of the customer's network containing IPv4 components, thereby providing IPv6 communication 111 between the customer's IPv6 enabled node 107 and the IPv6 entity 113 located outside of the customer's network containing IPv4 components.

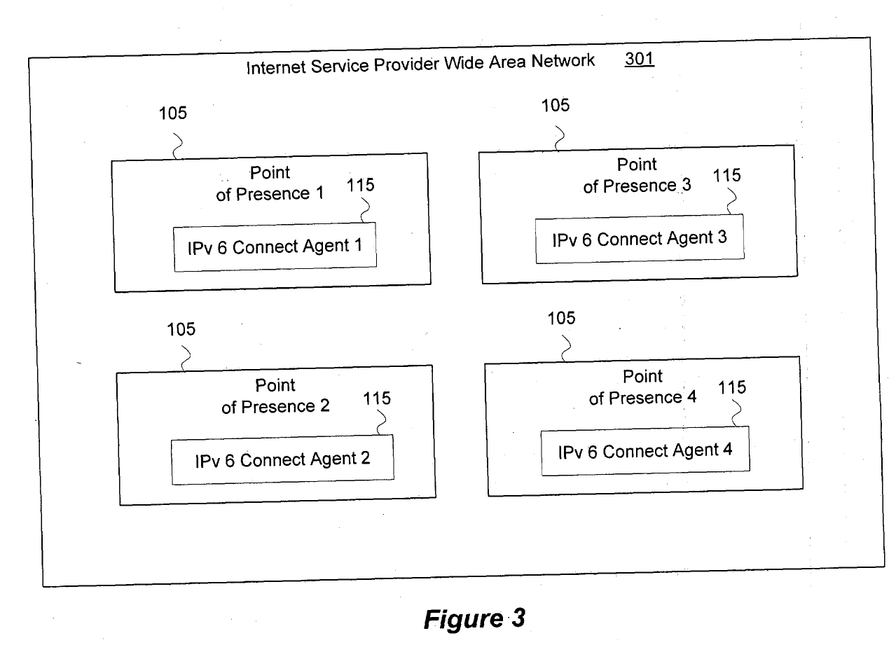

FIG. 3 illustrates an Internet Service Provider 101 that provides a plurality of points of presence 105 each including at least one IPv6 Connect Agent 115, according to one embodiment of the present invention. It is to be understood that in an embodiment such as the one illustrated in FIG. 3, the various points of presence 105 can be located anywhere in the world, as desired. Typically, the points of presence 105 reside within a wide area network 301 maintained by Internet Service Provider 101, as illustrated in FIG. 3. In such an embodiment, the Internet Service Provider 101 typically allows a customer's IPv6 enabled node 107 to discover the IPv6 Connect Agent 115 residing in the point of presence 105 that is physically most proximate to the customer. Of course, in some embodiments the customer can access other IPv6 Connect Agents 115 as desired, for example when the closest transition node 115 is unavailable.

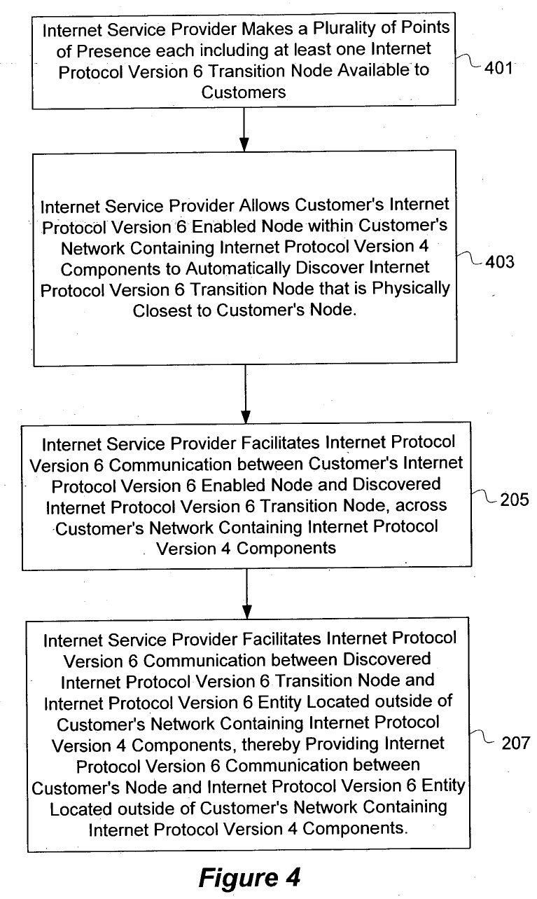

FIG. 4 illustrates steps for an Internet Service Provider 101 that includes a plurality of points of presence 105 to provide IPv6 connectivity to a customer without requiring that the customer upgrade its network containing IPv4 components, according to one embodiment of the present invention. The Internet Service Provider makes 401 a plurality of points of presence 105 each including at least one IPv6 Connect Agent 115 available to customers. The Internet Service Provider 101 allows 403 the customer's IPv6 enabled node 107 to automatically discover an IPv6 Connect Agent 115 that is physically closest to the customer's IPv6 enabled node 107.

The Internet Service Provider 101 proceeds to facilitate 205 IPv6 communication 111 between the customer's IPv6 enabled node 107 and the discovered IPv6 Connect Agent 115, across the customer's network containing IPv4 components. The Internet Service Provider also facilitates 207 IPv6 communication 111 between the discovered IPv6 Connect Agent 115 and an IPv6 entity 113 located outside of the customer's network containing IPv4 components, thereby providing IPv6 communication 111 between the customer's IPv6 enabled node 107 and the IPv6 entity 113 located outside of the customer's network containing IPv4 components.

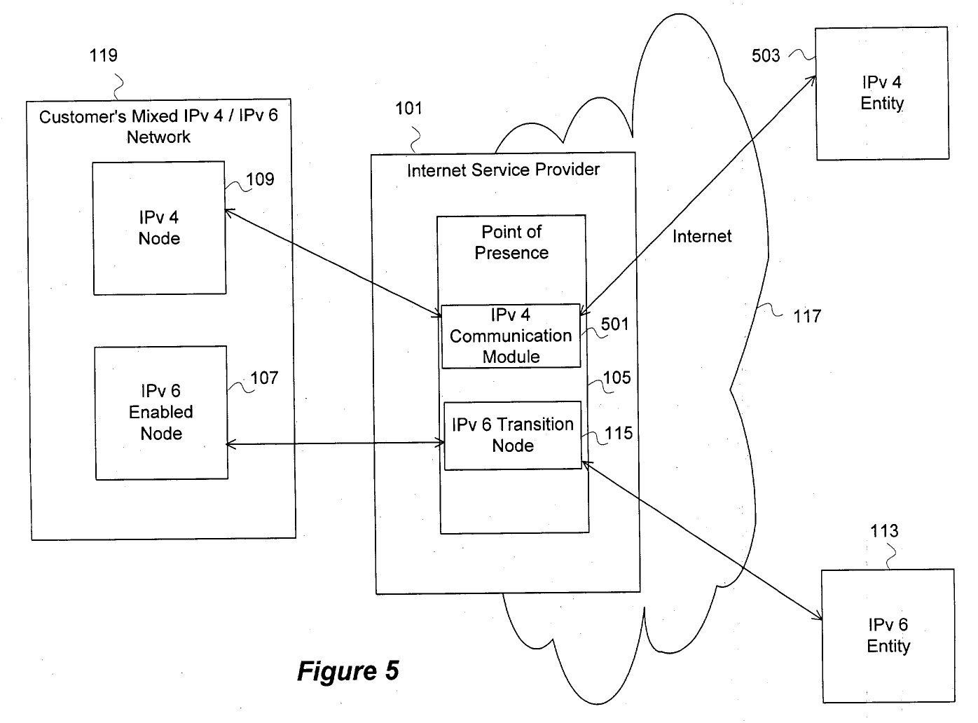

FIG. 5 illustrates another embodiment of the present invention, in which an Internet Service Provider 101 point of presence 105 also includes an IPv4 communication module 501. The Internet Service Provider 101 facilitates IPv6 communication 111 between the customer's IPv6 enabled node 107 and an external IPv6 entity 113 as described above. In addition, the Internet Service Provider 101 facilitates IPv4 communication between an IPv4 node 109 within the customer's network containing IPv4 components and an IPv4 entity 503 located outside of the customer's IPv4 network.

The Internet Service Provider 101 makes at least one point of presence 105 including at least one IPv4 communication module 501 available to customers. The Internet Service Provider 101 allows a customer's IPv4 node 109 located within the customer's network containing IPv4 components to automatically discover an IPv4 communication module 501, in a manner that will be apparent to those of ordinary skill in the relevant art.

The Internet Service Provider 101 then facilitates IPv4 communication between the customer's IPv4 node 109 and the discovered IPv4 communication module 501, across the customer's network containing IPv4 components. The Internet Service Provider 101 also facilitates IPv4 communication between the discovered IPv4 communication module 501 and an IPv4 entity 503 located outside of the customer's network containing IPv4 components, thereby providing IPv4 communication between the customer's IPv4 node 109 and the IPv4 entity 503 located outside of the customer's IPv4 network. The implementation mechanics of the Internet Service Provider 101 providing IPv4 communication between the customer's IPv4 node 109 and the IPv4 entity 503 located outside of the customer's network containing IPv4 components will be apparent to those of ordinary skill in the relevant art.

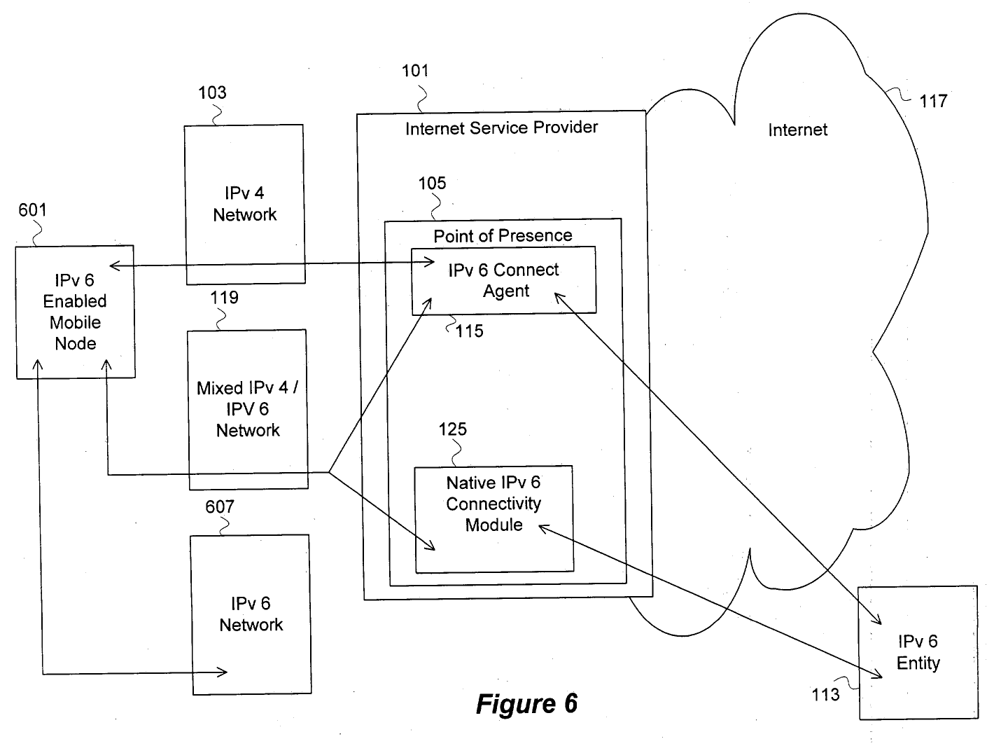

FIG. 6 illustrates an embodiment of the present invention in which the Internet Service Provider 101 facilitates mobile IPv6 communication 111 for a customer's IPv6 enabled mobile node 601. In general, an IPv6 enabled mobile node 601 can be moved from place to place, and connected to various networks as desired. IPv6 enabled mobile nodes 601 can communicate via mobile IPv6, a mobile version of the IPv6 standard, in a manner known to those of ordinary skill in the relevant art.

In some embodiments, the Internet Service Provider 101 facilitates mobile IPv6 communication 111 for a customer's IPv6 enabled mobile node 601, across the customer's IPv4 network 103. In some embodiments, the Internet Service Provider 101 makes one or more points of presence 105 including an IPv6 Connect Agent 115 available to customers, as explained above. The Internet Service Provider 101 allows a customer's IPv6 mobile node 601 to automatically discover an IPv6 Connect Agent 115 (for example, the IPv6 Connect Agent 115 that is physically closest to the customer's mobile node 601), in the manner explained above in the discussion of stationary nodes. In embodiments utilizing IPv6 enabled mobile nodes 601, the discovered IPv6 Connect Agent 115 can act as a virtual home agent, thereby enabling the Internet Service Provider 101 to facilitate IPv6 mobile communication without requiring the use of a permanent home agent. In some embodiments, the discovered IPv6 Connect Agent 115 (acting as a virtual home agent) authenticates the customer's IPv6 enabled mobile node 601, using a known authentication protocol such as AAA.

As illustrated in FIG. 6, the Internet Service Provider 101 ban facilitate mobile IPv6 communication between the customer's IPv6 enabled mobile node 601 and discovered IPv6 Connect Agent 115 through an IPv4 network 103, as well as between the discovered IPv6 Connect Agent 115 and an external IPv6 entity 113 (e.g., through the Internet 117). It is to be understood that the IPv6 enabled mobile node 601 can be moved from place to place, and connect to the Internet Service Provider through various networks as desired. As FIG. 6 illustrates, in some embodiments the IPv6 enabled mobile node 601 can connect to the Internet Service Provider through a mixed IPv4/IPv6 network 119. When the IPv6 enabled mobile node 601 connects through such a network, the Internet Service Provider 101 can allow the mobile node 601 to discover an IPv6 Connect Agent 115, as described above. Additionally, because the mixed IPv4/IPv6 network 119 includes native IPv6 functionality, the IPv6 enabled mobile node 601 can also connect to a native IPv6 connectivity module 605 provided by the Internet Service Provider 101, which facilitates native mobile IPv6 communication between the IPv6 enabled mobile node 601 and the external IPv6 entity 113 through the mixed IPv4/IPv6 network 119 in a manner that will be apparent to one of ordinary skill in the relevant art. As illustrated in FIG. 6, the IPv6 enabled mobile node 601 can also connect to a native IPv6 connectivity module 605 provided by the Internet Service Provider 101 through an IPv6 network 607. In that scenario, the native IPv6 connectivity module 605 facilitates native mobile IPv6 communication between the IPv6 enabled mobile node 601 and the external IPv6 entity 113 through the IPv6 network 607.

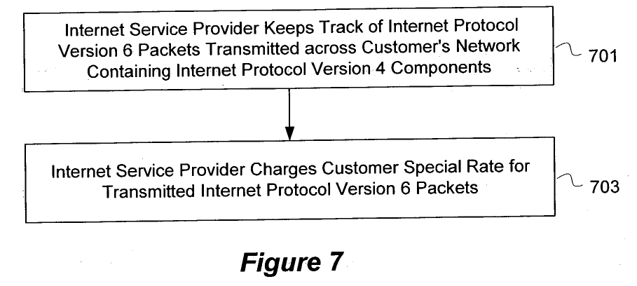

The Internet Service Provider 101 facilitating IPv6 communication 101 across a customer's network containing IPv4 components creates new opportunities for billing models, which are utilized in some embodiments of the present invention. FIG. 7 illustrates steps for executing one such billing model, according to one embodiment of the present invention. As the Internet Service Provider 101 facilitates IPv6 communication 111 across a customer's network containing IPv4 components, the Internet Service Provider 101 keeps track 701 of IPv6 packets transmitted across the customer's network containing IPv4 components. The Internet Service Provider 101 then charges 703 customers a special rate for transmitted IPv6 packets. Because an Internet Service Provider 101 transmitting IPv6 packets across an network containing IPv4 components is a special service, it can be desirable for the Internet Service Provider 101 to charge for this service at a higher rate. It will be apparent to those of ordinary skill in the relevant art that the embodiment illustrated in FIG. 7 can be practiced wherein the customer's IPv6 enabled node is stationary 107 or mobile 601, as desired. In some embodiments utilizing mobile nodes 601, the Internet Service provider 101 keeps track of the IPv6 packets transmitted across a mixed IPv4/IPv6 network 119 and/or an IPv6 network 607, and charges a distinct rate (higher or lower) as desired.

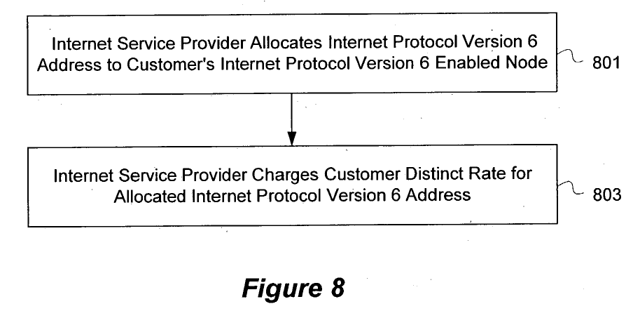

FIG. 8 illustrates steps for executing another billing model, according to another embodiment of the present invention. The Internet Service Provider 101 allocates 801 an Internet Protocol Version 6 address to at least one customer's IPv6 enabled node 107, within the context of facilitation of IPv6 communication 111. Because this is a special service, the Internet Service Provider 101 charges 803 the customer a special rate for each allocated IPv6 address.

As will be understood by those familiar with the art, the invention may be embodied in other specific forms without departing from the spirit or essential characteristics thereof. Likewise, the particular naming and division of the modules, features, attributes, methodologies, nodes, points of presence and other aspects are not mandatory or significant, and the mechanisms that implement the invention or its features may have different names, divisions and/or formats. Furthermore, as will be apparent to one of ordinary skill in the relevant art, the modules, features, attributes, methodologies, nodes, points of presence and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Furthermore, the present invention is not limited to an Internet Service Provider 101 facilitating IPv6 communication 111 over an network containing IPv4 components. In alternative embodiments, an Internet Service Provider 101 can instead implement communication according to other later generation communication protocols over other earlier generation protocol networks, as will be apparent in light of the specification to those of ordinary skill in the art. Accordingly, the disclosure of the present invention is intended to be illustrative, but not limiting, of the scope of the invention, which is set forth in the following claims.

What is claimed is:

1. A method for an Internet Service Provider to provide Internet Protocol Version 6 connectivity to a customer without requiring that the customer upgrade its network containing Internet Protocol Version 4 components, the method comprising:
the Internet Service Provider making at least one point of presence including at least one Internet Protocol Version 6 transition node available to customers;
the Internet Service Provider allowing a customer's Internet Protocol Version 6 enabled node located within the customer's network containing Internet Protocol Version 4 components to automatically discover an Internet Protocol Version 6 transition node;
the Internet Service Provider facilitating Internet Protocol Version 6 communication between the customer's Internet Protocol Version 6 enabled node and the discovered Internet Protocol Version 6 transition node, across the customer's network containing Internet Protocol Version 4 components; and
the Internet Service Provider facilitating Internet Protocol Version 6 communication between the discovered Internet Protocol Version 6 transition node and an Internet Protocol Version 6 entity located outside of the customer's network containing Internet Protocol Version 4 components, thereby providing Internet Protocol Version 6 communication between the customer's Internet Protocol Version 6 enabled node and the Internet Protocol Version 6 entity located outside of the customer's network containing Internet Protocol Version 4 components.

2. The method of claim 1 wherein:
the Internet Service Provider facilitating Internet Protocol Version 6 communication between the discovered Internet Protocol Version 6 transition node and an Internet Protocol Version 6 entity located outside of the customer's network containing Internet Protocol Version 4 components comprises the Internet Service Provider facilitating Internet Protocol Version 6 communication across the Internet.

3. The method of claim 1 further comprising:
the Internet Service Provider making a plurality of points of presence each including at least one Internet Protocol Version 6 transition node available to customers.

4. The method of claim 3 wherein:
the provided points of presence are located within an Internet Server Provider wide area network.

5. The method of claim 3 wherein:
the Internet Service Provider allowing the customer's Internet Protocol Version 6 enabled node to automatically discover an Internet Protocol Version 6 transition node provided by the Internet Service Provider comprises the Internet Service Provider allowing the customer's Internet Protocol Version 6 enabled node to automatically discover an Internet Protocol Version 6 transition node that is physically closest to the customer's Internet Protocol Version 6 enabled node.

6. The method of claim 1 further comprising:
the Internet Service Provider making at least one point of presence including at least one Internet Protocol Version 4 communication node available to customers;
the Internet Service Provider allowing a customer's Internet Protocol Version 4 node located within the customer's network containing Internet Protocol Version 4 components to automatically discover an Internet Protocol Version 4 communication node;
the Internet Service Provider facilitating Internet Protocol Version 4 communication between the customer's Internet Protocol Version 4 node and the discovered Internet Protocol Version 4 communication node, across the customer's network containing Internet Protocol Version 4 components; and
the Internet Service Provider facilitating Internet Protocol Version 4 communication between the discovered Internet Protocol Version 4 communication node and an Internet Protocol Version 4 entity located outside of the customer's network containing Internet Protocol Version 4 components, thereby providing Internet Protocol Version 4 communication between the customer's Internet Protocol Version 4 node and the Internet Protocol Version 4 entity located outside of the customer's network containing Internet Protocol Version 4 components.

7. The method of claim 1 wherein:
the customer's Internet Protocol Version 6 enabled node comprises an Internet Protocol Version 6 enabled mobile node; and
the Internet Protocol Version 6 communication facilitated by the Internet Service Provider comprises mobile Internet Protocol Version 6 communication.

8. The method of claim 7 further comprising:
the discovered Internet Protocol Version 6 transition node acting as a virtual home agent, providing Internet Protocol Version 6 communication between the customer's Internet Protocol Version 6 enabled mobile node and the Internet Protocol Version 6 entity located outside of the customer's network containing Internet Protocol Version 4 components without requiring use of a permanent home agent.

9. The method of claim 8 further comprising:
the discovered Internet Protocol Version 6 transition node authenticating the customer's Internet Protocol Version 6 enabled mobile node.

10. The method of claim 7 further comprising:
the Internet Service Provider making a plurality of points of presence each including at least one Internet Protocol Version 6 transition node capable of acting as a virtual home agent available to customers.

11. The method of claim 10 wherein:
the Internet Service Provider allowing the customer's Internet Protocol Version 6 enabled mobile node to automatically discover an Internet Protocol Version 6 transition node provided by the Internet Service Provider comprises the Internet Service Provider allowing the customer's Internet Protocol Version 6 enabled mobile node to automatically discover an Internet Protocol Version 6 transition node acting as a virtual home agent that is physically closest to the customer's Internet Protocol Version 6 enabled mobile node.

12. The method of claim 7 further comprising:
the Internet service provider facilitating native mobile Internet Protocol Version 6 communication between a customer's Internet Protocol Version 6 enabled mobile node and an Internet Protocol Version 6 entity through a network from a group of networks comprising: 1) a mixed Internet Protocol Version 4 and Internet Protocol Version 6 network; and 2) an Internet Protocol Version 6 network.

13. The method of claim 1 or 7 further comprising:
the Internet Service Provider keeping track of Internet Protocol Version 6 packets transmitted across the customer's network containing Internet Protocol Version 4 components; and
the Internet Service Provider charging the customer a special rate for Internet Protocol Version 6 packets transmitted across the customer's network containing Internet Protocol Version 4 components.

14. The method of claim 1 or 7 further comprising:
the Internet Service Provider allocating at least one Internet Protocol Version 6 address to at least one customer's Internet Protocol Version 6 enabled node; and
the Internet Service Provider charging the customer a special rate for each allocated Internet Protocol Version 6 address.

15. The method of claim 12 further comprising:
the Internet Service Provider keeping track of Internet Protocol Version 6 packets transmitted across a mixed Internet Protocol Version 4 and Internet Protocol Version 6 network; and
the Internet Service Provider charging the customer a distinct rate for Internet Protocol Version 6 packets transmitted across the mixed Internet Protocol Version 4 and Internet Protocol Version 6 network.

16. The method of claim 12 further comprising:
the Internet Service Provider keeping track of Internet Protocol Version 6 packets transmitted across an Internet Protocol Version 6 network; and
the Internet Service Provider charging the customer a distinct rate for Internet Protocol Version 6 packets transmitted across the Internet Protocol Version 6 network.

17. A system for an Internet Service Provider to provide Internet Protocol Version 6 connectivity to a customer without requiring that the customer upgrade its network containing Internet Protocol Version 4 components, the system comprising:
an Internet Service Provider network comprising a plurality of points of presence;
at least one Internet Protocol Version 6 transition node, located within a point of presence, the Internet Protocol Version 6 transition node being communicatively coupled to a customer's Internet Protocol Version 6 enabled node located in the customer's network containing Internet Protocol Version 4 components, and to an Internet Protocol Version 6 entity located outside of the customer's network containing Internet Protocol Version 4 components.

18. The system of claim 17 further comprising:
at least one Internet Protocol Version 4 communication node, located within a point of presence, the Internet Protocol Version 4 communication node being communicatively coupled to a customer's network containing Internet Protocol Version 4 components, and to an Internet Protocol Version 4 entity located outside of the customer's network containing Internet Protocol Version 4 components.

19. The system of claim 17 further comprising:
a native Internet Protocol Version 6 communication module located within the Internet Service Provider network, the Internet Protocol Version 6 communication module being communicatively coupled to an Internet Protocol Version 6 entity and to a network from a group of networks comprising: 1) a mixed Internet Protocol Version 4 and Internet Protocol Version 6 network; and 2) an Internet Protocol Version 6 network.

20. A method for an Internet Service Provider to provide connectivity to a customer according to a later generation communication protocol, without requiring that the customer upgrade its network containing earlier generation communication protocol components, the method comprising:
the Internet Service Provider making at least one point of presence including at least one later generation communication protocol transition node available to customers;
the Internet Service Provider allowing a customer's later generation communication protocol enabled node located within the customer's network containing earlier generation communication protocol components to automatically discover a later generation communication protocol transition node;
the Internet Service Provider facilitating later generation communication protocol communication between the customer's later generation communication protocol enabled node and the discovered later generation communication protocol transition node, across the customer's network containing earlier generation communication protocol components; and
the Internet Service Provider facilitating later generation communication protocol communication between the discovered later generation communication protocol transition node and a later generation communication protocol entity located outside of the customer's network containing earlier generation communication protocol components, thereby providing later generation communication protocol communication between the customer's later generation communication protocol enabled node and the later generation communication protocol entity located outside of the customer's network containing earlier generation communication protocol components.

21. The method of claim 20, further comprising:
the Internet Service Provider keeping track of later generation communication protocol packets transmitted across the customer's network containing earlier generation communication protocol components; and
the Internet Service Provider charging the customer a special rate for later generation communication protocol packets transmitted across the customer's network containing earlier generation communication protocol components.
